(19) United States
(12) Patent Application Publication
(10) Pub. No.: US 2004/0085055 A1
(43) Pub. Date: May 6, 2004

(54) Voltage regulation for spatially remote users

(76) Inventor: Stephan Lederer, Hallerndorf (DE)

Correspondence Address: SCHIFF HARDIN, LLP, PATENT DEPARTMENT, 6600 SEARS TOWER, CHICAGO, IL, 60606-6473, US

(21) Appl. No.: 10/635,376

(22) Filed: Aug. 6, 2003

(30) Foreign Application Priority Data
Aug. 7, 2002 (DE) 102 36 166.5

(51) Int. Cl. G05F 1/00

(52) U.S. Cl. 323/318

(57) ABSTRACT

In a voltage regulator for a spatially remote user, an adjustable voltage supply is provided for the user along with a measuring instrument allocated to the user. A sensor line is provided for the transmission of a measured signal to a setting device which in turn controls the voltage supply.

### BACKGROUND OF THE INVENTION

The invention is directed to voltage regulation for a spatially remote user with an adjustable voltage supply for the user, with a measuring instrument and with a setting device for the voltage supply.

As a boundary condition, the standard realization should thereby be foregone, i.e. arranging the regulator at the user, in order to avoid the dissipated powers or disturbances that otherwise additionally occur thereat given employment of a linear regulator or switched regulator.

A voltage regulator with sensor lines as described in the book Halbleiter-Schaltungstechnik by U. Tietze and Ch. Schenk, 7^{th} Amended Edition, 1985, page 529, can be taken for such purposes. The voltage at a user arranged at a spatially remote location is thereby kept constant via the voltage regulator. So that the voltage drop-off at the resistances of the lines can be taken into consideration, sensor terminals that are connected to the voltage regulator via sensor lines for measuring the voltage are provided at the user.

FIG. 1 shows such a voltage regulator 1 for a spatially remote user 2 with a load resistance 3. The user 2 is connected via lines to the voltage regulator 1 via lines with line resistances 4 as well as the sensor lines 5. The voltage regulator 1 comprises a constant voltage source 6 that is connected to the non-inverting input of an operational amplifier (OP) 7. The middle of a voltage divider 8 connected to the sensor lines 5 is connected to the inverting input of the operational amplifier 7. The output of the operational amplifier 7 connects to a voltage source 9, which, for example, can be regulated by a transistor, for setting the voltage for the user 2.

The voltage is transmitted analogously from the user 2 to the voltage regulator 1 via two sensor lines 5. Particularly given long lines, disturbances on the sensor lines 5 that disadvantageously influence the voltage regulation can be intercepted.

### SUMMARY OF THE INVENTION

It is an object of the invention to design a voltage regulator of the species initially cited such that it manages, with less expense for the transmission of the measured voltage and, additionally, is less prone to interference.

A voltage regulation system is provided for a spatially remote user comprising an adjustable voltage supply for the user. A measuring circuit produces a measured signal allocated to the user. A sensor line for the transmission of the measured signal is provided. A setting device is connected to the voltage supply.

### BRIEF DESCRIPTION OF THE DRAWINGS

FIG. 1 is a voltage regulator of the Prior Art; and

FIG. 2 is a preferred embodiment of the voltage regulator.

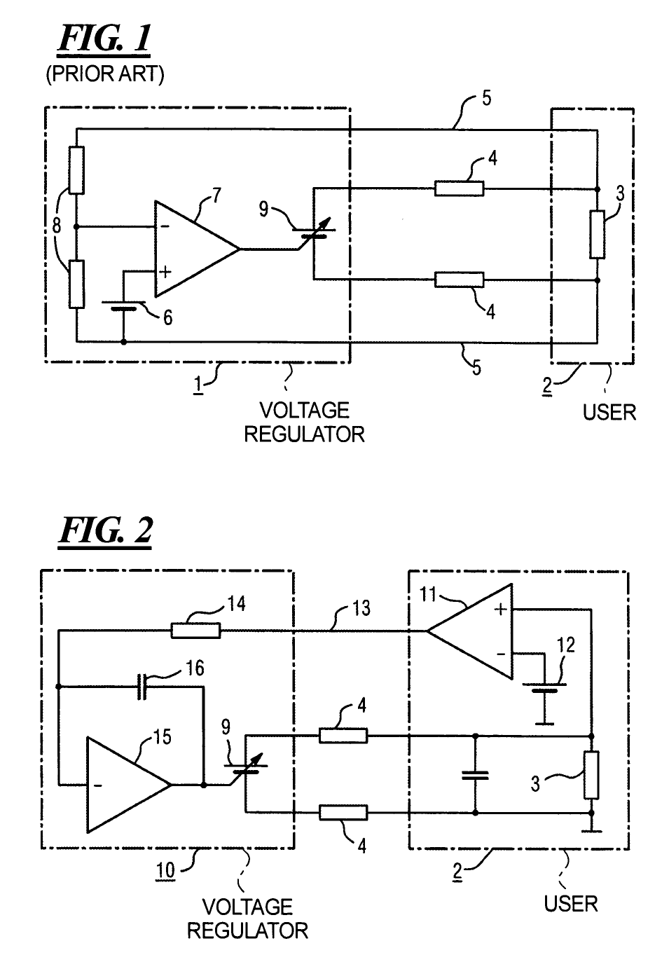

A measuring instrument is allocated to the user and is connected to a setting device for the voltage supply by a sensor line for the transmission of a measured signal. The acquisition of the voltage at the user ensues as a result thereof. The deviation of the actual voltage from the rated voltage is supplied to the controllable voltage source as a digital signal via a single sensor line, the voltage source being correspondingly readjusted so that a constant voltage is present at the user.

It has proven advantageous when the measuring instrument comprises a comparator that compares the voltage present at the user to the voltage at a reference voltage source.

Advantageously, the setting device for the voltage supply can comprise an integrator that influences the setting element of the adjustable voltage supply.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

FIG. 2 shows the voltage regulator. A controllable voltage source 9 arranged in the voltage regulator 10 is connected to the user 2 via connecting lines having the line resistances 4. The voltage is taken at the load resistor 3 of the user 2 and is supplied to the non-inverting input of an OP amplifier 11 allocated to the user 2, whereas a constant reference voltage source 12 lies at the inverting input. The OP amplifier 11 thus works as a comparator. The output of the Op amplifier 11 is connected via a sensor line 13 and a resistor 14 to the input of an inverting OP amplifier 15 that is fedback via a capacitor 16 and operates as an integrator. The output of the inverting OP amplifier 15 is connected to the setting element of the controllable voltage source 9.

As a result of the arrangement, the acquisition of the voltage occurs at the user, whereby the deviation is supplied—as a digital signal via a single sensor line 13—to the controllable voltage source 9 that is correspondingly readjusted so that a constant voltage is present at the user 2.

The digital signal needs only two statuses (two-point regulation) or three statuses (three-point regulation). For the three-point regulation, for example, it can amount to +H (high) when the voltage is too high, to M (medium voltage, for example H/2) when the voltage is correct or to L (low) when the voltage is too low. An arbitrary voltage that the OP amplifier 11 supplies at its output thus stands for H.

The advantage of voltage regulation of spatially remote users is that only a single sensor line is required, since the setting occurs digitally. As a result thereof, no involved filtering of the sensor line 13 is required, so that a high resistance to interference results. A saving of a line results compared to the known solution wherein the regulator is in fact likewise arranged in the voltage regulator 1, but two lines are required. Compared to the alternative known solution of arranging the regulator at the user, additional dissipated power and interference at the user are avoided. The interferences are even additionally filtered by the long cable link. A very high precision derives as a result of the reference. The residual ripple can be kept low by adaptation of regulating speed and load capacitances.

It is thus important that the regulator is not arranged at the user, that the actual measurement of the voltage occurs user-proximate, and that the comparison result is digitally transmitted to the voltage regulator 10.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1. A voltage regulation system for a spatially remote user, comprising:
an adjustable voltage supply for the user;
a measuring circuit producing a measured signal allocated to the user;
a sensor line for transmission of said measured signal; and
a setting device connected to the voltage supply.

2. The voltage regulation system according to claim 1 wherein the measuring circuit comprises a comparator that compares a voltage present at the user to a voltage of a reference voltage source.

3. The voltage regulation system according to claim 1 wherein the setting device comprises an integrator that influences a setting element of the adjustable voltage supply.

4. The voltage regulation system according to claim 1 wherein the setting device comprises a resistor connecting the sensor line to an input of an inverting operational amplifier, an output of the inverting operational amplifier connecting to control the voltage supply, and a capacitor being connected between an output of the inverting operational amplifier and said inverting operational amplifier input.

5. A voltage regulation system, comprising:
a voltage regulator comprising a variable voltage supply, and a setting circuit connected to vary the voltage supply;
a remote user having first and second voltage supply lines each having an associated line resistance and connecting the voltage supply of the voltage regulator to a load of the remote user; and
at the user, a measuring circuit having as an input a sensed signal from the load and an output connected via a single sensor line only to an input of said setting circuit.

6. The system according to claim 5 wherein the measuring circuit comprises an operational amplifier having a constant reference voltage source at one input and said sensed signal from said user load at the other input.

7. The system according to claim 5 wherein said setting circuit comprises an inverting operational amplifier having its output connected to said voltage supply and its input connected to said sensor line.

8. The system according to claim 7 wherein said inverting operational amplifier has a capacitor connected between its input and its output and comprises an integrator.

9. A method for regulating a remote user, comprising the steps of:
providing a voltage supply positioned remotely from said remote user;
providing a measurement circuit at said remote user which outputs a signal indicative of an operating condition of a load of said remote user, said signal being sent on single sensor line only; and
adjusting said voltage supply located remotely from said user by use of said signal from said single sensor line.

10. The method according to claim 9 wherein said signal is integrated for control of said voltage supply.

11. The system according to claim 9 wherein said signal on said single sensor line is digital.
